(19) United States
(12) Patent Application Publication
(10) Pub. No.: US 2026/0131298 A1
(43) Pub. Date: May 14, 2026

(54) AMMONIA COMBUSTION AND REFORMING SYSTEM FOR HIGH-EFFICIENCY HYDROGEN PRODUCTION

(71) Applicant: Pusan National University Industry-University Cooperation Foundation, Busan (KR)

(72) Inventors: Chung Hwan JEON, Busan (KR); Byoung Hwa LEE, Busan (KR); Seung-Mo KIM, Busan (KR)

(21) Appl. No.: 19/389,935

(22) Filed: Nov. 14, 2025

(30) Foreign Application Priority Data
Nov. 14, 2024 (KR) 10-2024-0161655

(51) Int. Cl. B01J 12/00; B01J 4/00; B01J 19/00; B01J 19/26; C01B 3/04

(52) U.S. Cl. CPC B01J 12/005; B01J 4/002; B01J 19/0013; B01J 19/26; C01B 3/047; B01J 2204/002; B01J 2204/005; B01J 2219/00157

(57) ABSTRACT

The ammonia combustion and reforming system for high-efficiency hydrogen production includes a combustion chamber, a fuel injection unit that generates a combustion gas by combusting at least first air and first ammonia inside the combustion chamber, and an ammonia decomposition unit that is at least partially provided inside the combustion chamber and in which ammonia for decomposition is decomposed, wherein thermal energy of the combustion gas is transferred to the inside of the ammonia decomposition unit, so that the ammonia for decomposition is decomposed to generate a decomposition gas.

### CROSS-REFERENCE TO RELATED APPLICATION

The present application claims priority under 35 U.S.C. § 119(a) to Korean Patent Application No. 10-2024-0161655 filed in the Korean Intellectual Property Office on Nov. 14, 2024, which is incorporated herein by reference in its entirety.

### TECHNICAL FIELD

The present disclosure relates to an ammonia combustion and reforming system for high-efficiency hydrogen production, which produces hydrogen by reforming/decomposing ammonia based on ammonia combustion.

### TECHNICAL BACKGROUND OF THE INVENTION

Hydrogen is attracting attention as an eco-friendly energy source such as fuel/cell. On the other hand, hydrogen has a low energy density and is difficult to transport, so it is transported and handled in the form of ammonia. It is known that such ammonia transportation and hydrogen production are very advantageous for distributed generation.

In addition, various catalysts are used to reform/decompose ammonia into hydrogen. For example, in the preceding Korean Patent Publication No. 10-2024-0125086, a method for manufacturing an ammonia decomposition catalyst, an ammonia decomposition catalyst manufactured therefrom, and a hydrogen production method using the same are disclosed.

On the other hand, high heat or other high energy injection is essential to reform/decompose ammonia into hydrogen. However, in order to generate high heat for ammonia decomposition/reforming, a large amount of fossil fuel must be burned, which causes a problem in that a large amount of carbon-based environmental pollutants are generated.

Furthermore, even if ammonia gas is used instead of fossil fuel to generate high heat for ammonia decomposition/reforming, environmentally harmful substances such as nitrogen oxides (NOx) are generated.

### CONTENTS OF THE INVENTION

### Problem to Be Solved

As part of solving the above-described problem, the present disclosure aims to provide an ammonia combustion and reforming system for high-efficiency hydrogen production, which can produce hydrogen gas through ammonia decomposition while reducing the emission of environmental pollutants such as nitrogen oxides.

### Means for Solving the Problem

The ammonia combustion and reforming system for high-efficiency hydrogen production according to the present disclosure includes a combustion chamber, a fuel injection unit that generates a combustion gas by combusting at least first air and first ammonia inside the combustion chamber, and an ammonia decomposition unit that is at least partially provided inside the combustion chamber and in which ammonia for decomposition is decomposed, wherein thermal energy of the combustion gas is transferred to the inside of the ammonia decomposition unit, so that the ammonia for decomposition is decomposed to generate a decomposition gas.

In addition, the ammonia decomposition unit has an inlet connected to the outside of the combustion chamber, and an outlet provided inside the combustion chamber, and includes a raw material supply pipe for decomposition provided to introduce a material to be decomposed, and at least a part of which is provided inside the combustion chamber, and communicated with the raw material supply pipe for decomposition, and a decomposed gas outlet pipe that transfers the decomposed gas to the outside of the combustion chamber.

In addition, the decomposition target material inlet pipe has an inlet end and an outlet end opened, and the decomposition gas outlet pipe faces the outlet end of the decomposition target material inlet pipe and is spaced apart from the outlet end of the decomposition target material inlet pipe by a predetermined distance, and includes an inlet-side partition wall and an outer pipe extending from the inlet-side partition wall, surrounding an outer wall of the decomposition target material inlet pipe, and spaced apart from an outer wall of the decomposition gas inlet pipe by a predetermined distance, and the decomposition gas is supplied to the outside of the combustion chamber through an outlet of the outer pipe.

And a exhaust manifold installed at an inlet end of the combustion path, communicated with an inside of the combustion path to discharge the combustion gas, wherein at least a part of the combustion gas circulates at least once along a long axis of the combustion path and then flows into the exhaust manifold.

The combustion chamber may include a main structure formed as an internally hollow structure with both ends open, a first partition wall part closing an inlet end of the main structure, and a second partition wall part closing an outlet end of the main structure.

In addition, the exhaust manifold is provided coaxially with the first partition wall at the outer side of the first partition wall.

In addition, the combustion chamber includes a plurality of intermediate discharge passages formed along a circumferential direction of an edge side of the first partition wall part and spaced apart from each other by a predetermined distance, and the exhaust manifold is provided along an edge direction of the first partition wall part and has a closed structure. a manifold body part; a passage connection part provided along a circumferential direction of the manifold body part and communicated with the plurality of intermediate discharge passages; and a main exhaust port communicating the inside and outside of the manifold body part.

The fuel injection unit further includes a main air injection tube through which the first air is discharged, a plurality of main passing holes formed in a hole structure along a circumferential direction of an inlet end of the main air injection tube and spaced a predetermined distance from each other, and an air injection case configured to surround the plurality of main passing holes and supply the first air to the plurality of main passing holes.

The fuel injection unit is provided between the air injection case and the plurality of main passage holes, and includes an air dividing part surrounding the plurality of main passage holes, and a plurality of air division holes formed in a hole structure along a circumferential direction of the air dividing part and spaced apart from each other by a predetermined distance.

Further, the plurality of air division holes are spaced apart from the plurality of main passing holes by a predetermined distance along the inlet direction of the main air injection tube.

And a auxiliary ammonia injection unit provided outside the fuel injection unit and injecting a second ammonia into the combustion chamber.

The auxiliary ammonia injection unit may include an auxiliary ammonia transfer pipe through which the second ammonia flows, and an auxiliary injection nozzle provided at an outlet end of the auxiliary ammonia transfer pipe.

The auxiliary injection nozzle further includes an auxiliary nozzle body and a front nozzle hole formed in a hole structure along a flow direction at an exit end side of the auxiliary nozzle body.

Further, the forward nozzle hole has a slope that increases a separation distance from the fuel injection unit toward an exit direction, surrounds an outside of the fuel injection unit, and has a recirculation guide part having a slope that increases a separation distance from the fuel injection unit toward the exit direction.

Further, the auxiliary injection nozzle includes a plurality of side nozzle holes formed in a hole structure along a circumferential direction of the auxiliary nozzle body.

Further, the side nozzle hole is orthogonal to the long axis of the nozzle body, and an outlet end thereof faces the inner surface of the recirculation guiding part.

### Effects of the Invention

According to the ammonia combustion and reforming system for high-efficiency hydrogen production of the present disclosure, thermal energy generated by combusting ammonia for combustion is transferred to ammonia for decomposition. By the principle of heat transfer, the ammonia for decomposition is decomposed to produce clean hydrogen gas.

At this time, in the combustion chamber, complete combustion of the ammonia for combustion is induced, so that the amount of nitrogen oxides (NOx) generated due to incomplete combustion is minimized.

### BRIEF DESCRIPTION OF THE DRAWINGS

FIG. 1 is a perspective view illustrating an ammonia combustion and reforming system for high-efficiency hydrogen production according to the present disclosure.

FIG. 2 is a cross-sectional view of FIG. 1.

FIG. 3 is a cross-sectional view illustrating a state viewed in a 3-3′ direction shown in FIG. 2.

FIG. 4 is an enlarged view illustrating the ammonia decomposition unit shown in FIG. 2.

FIG. 5 is a perspective view illustrating the fuel injection unit shown in FIG. 1.

FIG. 6 is a side cross-sectional view of FIG. 5.

FIG. 7 is a cross-sectional view illustrating a state viewed in a direction 7-7′ shown in FIG. 6.

FIG. 8 is a cross-sectional view illustrating a state viewed in a direction 8-8′ shown in FIG. 6.

FIG. 9 is a perspective view showing the auxiliary injection nozzle shown in FIG. 6.

FIG. 10 is a side cross-sectional view showing the auxiliary injection nozzle shown in FIG. 6.

FIG. 11 is a schematic diagram illustrating a fluid flow on the side of the fuel injection part and the auxiliary ammonia injection part shown in FIG. 6.

FIG. 12A is a computational fluid dynamics analysis result showing a difference in fluid flow velocity distribution between Example 1 and Comparative Example 1.

FIG. 12B is a computational fluid analysis result showing a temperature vector difference between Example 1 and Comparative Example 1.

FIG. 12C is a computational fluid dynamics analysis result showing a difference in temperature distribution on the ammonia decomposition unit side between Example 1 and Comparative Example 1.

FIG. 12D is a computational fluid dynamics analysis result showing the difference in nitrogen oxide concentration distribution between Example 1 and Comparative Example 1.

FIG. 13A is a computational fluid dynamics analysis result showing the difference in stoichiometric coefficient distribution between Example 1 and Comparative Example 2.

FIG. 13B is a computational fluid analysis result showing the difference in stoichiometric coefficient distribution on the recirculation inducer side for Example 1 and Comparative Example 2.

FIG. 13C is a computational fluid dynamics analysis result showing the difference in nitrogen oxide concentration distribution on the recirculation inducing unit side for Example 1 and Comparative Example 2.

### DETAILED DESCRIPTION OF THE INVENTION

Prior to the detailed description of the present disclosure, specific matters for carrying out the present disclosure are included in the embodiments and drawings to be described below. Also, the same reference numerals described throughout the specification refer to the same components. Also, the singular expressions in the present specification include plural expressions unless specifically mentioned in the phrases.

Hereinafter, a highly efficient hydrogen production system using ammonia combustion and reforming according to the present disclosure will be described with reference to the drawings.

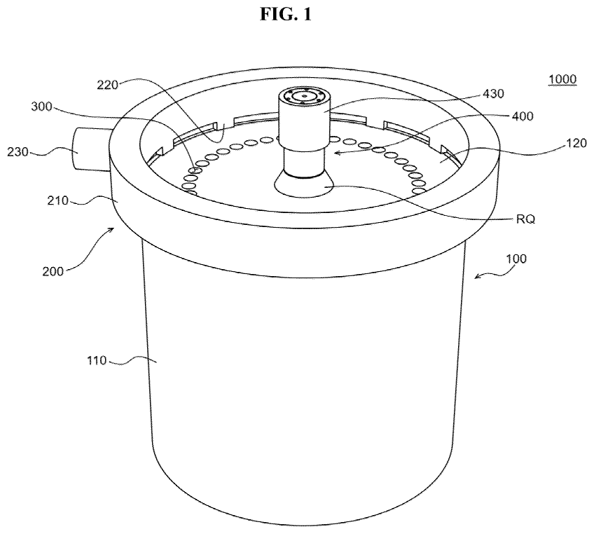

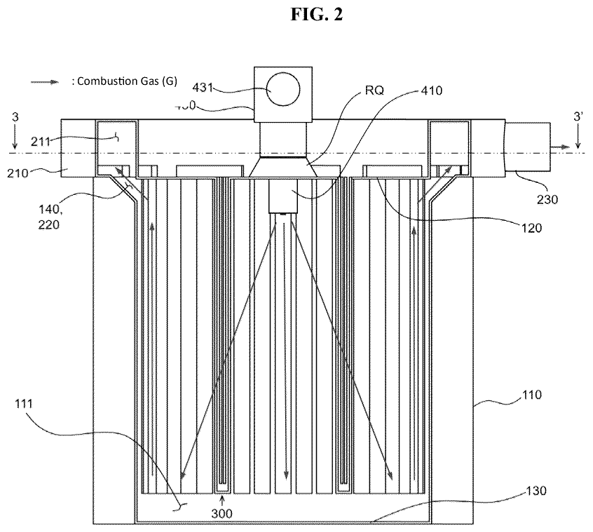

FIG. 1 is a perspective view illustrating an ammonia combustion and reforming system for high-efficiency hydrogen production according to the present disclosure. And, FIG. 2 is a front cross-sectional view of FIG. 1.

Referring to FIGS. 1 and 2, an ammonia combustion and reforming system (1000) for efficient hydrogen production includes a combustion chamber (100), an exhaust manifold (200), an ammonia decomposition unit (300), a fuel injection unit (400), and an auxiliary ammonia injection unit (500).

The combustion chamber 100 is formed into a combustion chamber structure for ammonia combustion and ammonia reforming/decomposition. The combustion chamber 100 includes a main structure 110, a first partition wall part 120, a second partition wall part 130, and an intermediate discharge passage 140.

The main structure (110) is formed as an internally hollow structure having open ends. The inside of the main structure (110) is defined as a combustion space (111) in which a combustion operation is performed.

And, the first partition part (120) seals the inlet end of the main structure (110). Here, the fuel injection part (400) is installed to penetrate the first partition part (120).

And, the second partition part (130) seals the outlet end of the main structure (110).

And, the intermediate discharge passage (140) is formed in a hole structure on the edge side of the first partition wall part (120). In addition, a plurality of intermediate discharge passages (140) are provided along the circumferential direction of the edge of the first partition wall part (120). A predetermined interval is set between the plurality of intermediate discharge passages (140).

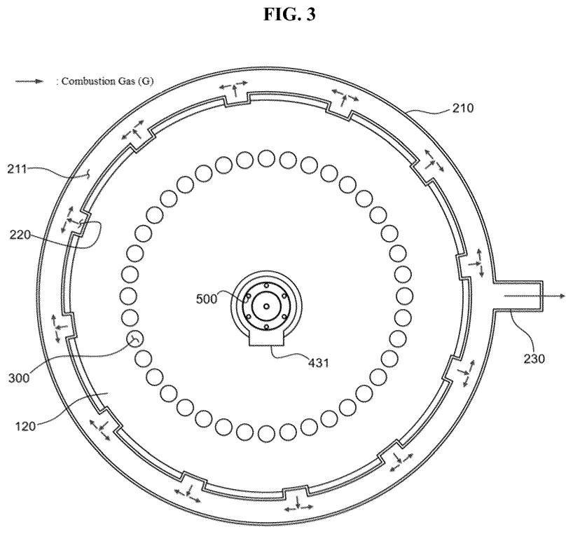

Next, FIG. 3 is a cross-sectional view illustrating a state viewed in a direction 3-3′ shown in FIG. 2.

Referring further to FIG. 3, the exhaust manifold 200 includes a manifold body 210, a passage connecting part 220, and a main exhaust port 230.

The manifold body part 210 is installed outside the first partition wall part 120. The manifold body part 210 is provided coaxially with the long axis of the combustion chamber 100. Further, the manifold body part 210 is provided along the peripheral direction of the edge side of the first partition wall part 120.

The manifold body part (210) is formed in a sealed internal hollow structure. Preferably, the middle inflow space (211) inside the manifold body part (210) may have a predetermined width and be provided to be circulated along the circumferential direction of the first partition wall part (120).

And, the passage connection part (220) is formed in a groove structure along the circumferential direction of the manifold body part (210). In addition, a plurality of passage connection parts (220) are provided to communicate with the plurality of intermediate discharge passages (140).

And, the main exhaust part (230) is provided on one side of the manifold body part (210). The main exhaust part (230) communicates the inside and outside of the intermediate inflow space (211). The combustion gas (G) discharged from the main exhaust part (230) can be used for other types of power generation, such as thermal power.

Here, the combustion gas (G) generated by the fuel injection unit (400) is injected from the first partition wall unit (120) toward the second partition wall unit (130).

Next, the combustion gas (G) collides with the second partition wall part (130) and circulates in the direction of the first partition wall part (120).

Next, the combustion gas (G) circulated from the second partition wall part (130) to the first partition wall part (120) flows into the intermediate inflow space (211) through the intermediate discharge passage (140) and the passage connection part (220). At this time, corresponding to the number of the intermediate discharge passages (140), the combustion gas (G) flows into the intermediate inflow space (211) omni-directionally/simultaneously along the circumferential direction of the first partition wall part (120).

Next, the combustion gas (G) introduced into the intermediate introduction space (211) is discharged to the outside through the main exhaust port (230). Here, although not shown in detail, the main exhaust port (230) may be transferred to the atmosphere, an exhaust gas treatment means, an exhaust gas storage means, and various other means/locations.

The time that the combustion gas (G) flows/stays in the combustion space 111 can be freely adjusted as much as the number of the above-described multiple intermediate discharge passages 140.

Further, by the intermediate discharge passages 140, the outlets through which the combustion gas G is discharged are uniformly provided along the circumferential direction of the combustion chamber 100. Thus, the combustion gas G is distributed as evenly as possible inside the combustion space 111.

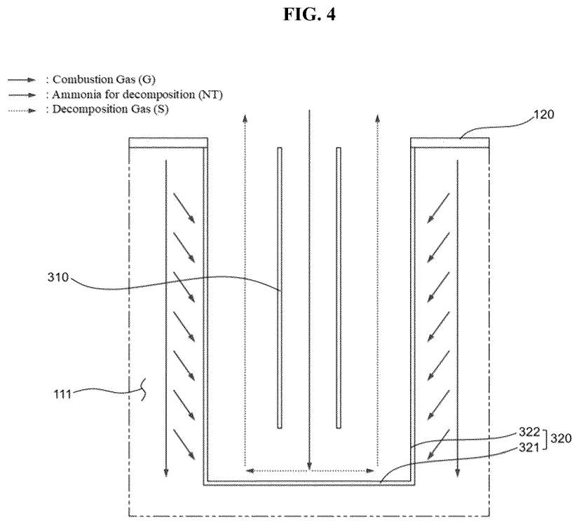

FIG. 4 is an enlarged view illustrating the ammonia decomposition unit shown in FIG. 2.

Referring further to FIG. 4, the ammonia decomposition unit (300) decomposes the decomposition ammonia (NT). As the decomposition ammonia (NT) is decomposed, a decomposition gas(S) is formed. The decomposition gas(S) includes at least hydrogen gas and nitrogen gas.

Also, the ammonia decomposition unit 300 includes a decomposition target material inlet pipe 310 and a decomposition gas outlet pipe 320.

The decomposition target material inlet pipe 310 is provided inside the combustion space 111. The decomposition target material inlet pipe 310 is provided along the long axis of the combustion chamber 100.

The inlet end of the raw material inlet pipe 310 to be decomposed communicates with the outside of the first partition wall 120. In addition, ammonia for decomposition (NT) may be supplied from a separate ammonia storage (not shown) to the inlet end of the raw material inlet pipe 310 to be decomposed. In addition, the outlet end of the raw material inlet pipe 310 to be decomposed is provided to face the second partition wall 130.

And, the decomposition gas outlet pipe (320) includes an inlet-side partition wall (321) and an outer pipe (322).

More specifically, the inlet-side partition wall 321 faces the outlet end of the feedstock introduction pipe 310. Further, the inlet-side partition wall 321 is spaced a predetermined distance from the outlet end of the feedstock introduction pipe 310 toward the second partition wall part 130.

And, the outer tube (322) extends from the inlet side partition wall (321) toward the first partition wall part (120). In addition, the outer tube 322 is provided to surround the outer wall of the raw material inlet pipe 310 to be decomposed, thereby forming a kind of double tube structure.

Accordingly, an inner diameter of the outer tube 322 is formed to be larger than an outer diameter of the raw material inlet tube 310, and the outer tube 322 and the raw material inlet tube 310 are spaced apart from each other by a predetermined distance in a radial direction.

That is, inside the double tube structure, the outlet end of the material-to-be-decomposed inlet tube (310) and the inlet end of the outer tube (322) communicate with each other. The outlet end of the outer tube (322) is provided to surround the outside of the inlet end of the material-to-be-decomposed inlet tube (310).

In the combustion space 111, thermal energy of the combustion gas G is transferred to the inside of the ammonia decomposition unit 300. By this thermal energy, the ammonia for decomposition NT inside the ammonia decomposition unit 300 is decomposed into the decomposition gas S. In particular, due to the above-described double pipe structure, the path and time that the ammonia for decomposition NT flows/stays inside the combustion space 111 increase, thereby improving ammonia decomposition efficiency.

In addition, the ammonia decomposition unit (300) may be provided in plurality along the circumferential direction of the first partition wall. In addition, although not shown in detail, the ammonia decomposition unit (300) may have a conductor that is at least partially bent or curved.

In addition, an ammonia decomposition catalyst (not shown) may be provided inside the ammonia decomposition unit (300).

In addition, the decomposition gas(S) passing through the decomposition gas outlet pipe 320 may be transferred to a separate decomposition storage (not shown). For example, only the pure hydrogen gas component of the decomposition gas(S) may be selectively collected. In addition, various components of the decomposition gas(S) may be selectively collected.

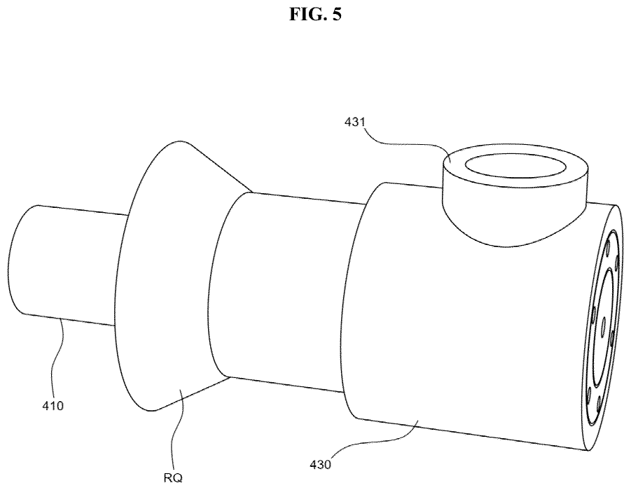

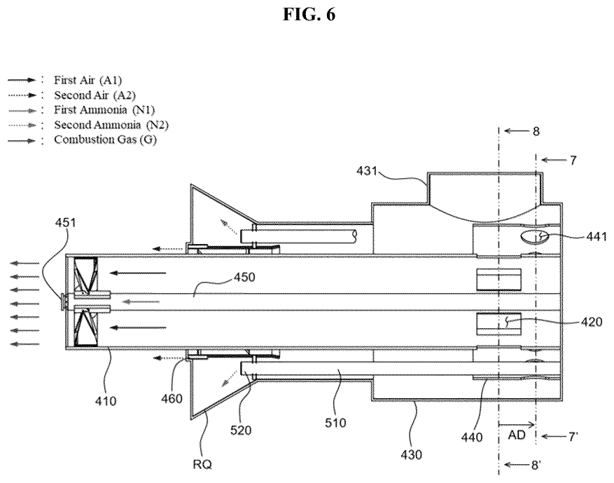

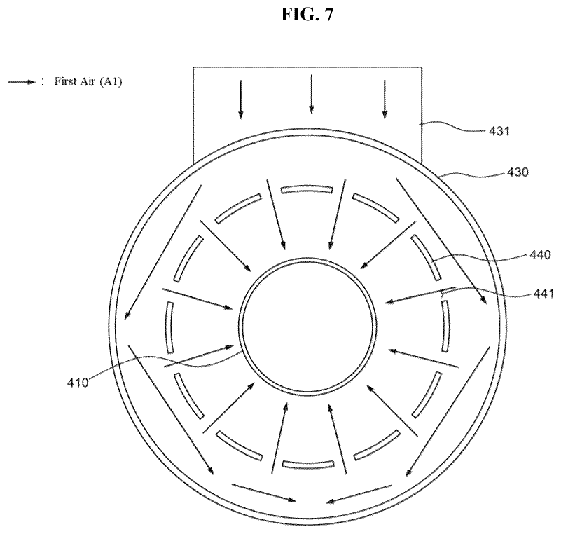

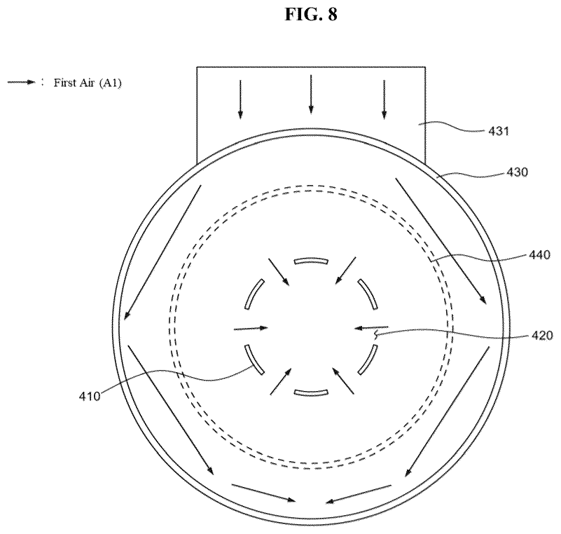

Next, FIG. 5 is a perspective view illustrating the fuel injection unit shown in FIG. 1. FIG. 6 is a side cross-sectional view of FIG. 5. FIG. 7 is a cross-sectional view illustrating a state viewed in a direction of 7-7′ shown in FIG. 6. FIG. 8 is a cross-sectional view illustrating a state viewed in a direction of 8-8′ shown in FIG. 6.

Referring to FIGS. 5 to 8, the fuel injection unit 400 generates the aforementioned combustion gas G by combusting at least the first air A1 and the first ammonia N1. For this combustion, a separate ignition device (not shown) is applied to the fuel injection unit 400. In this case, the first air A1 may correspond to a kind of primary air.

The fuel injection unit 400 includes a main air injection tube 410, a main passage hole 420, an air injection case 430, an air dividing part 440, a main ammonia injection part 450, and an auxiliary air injection part 460.

The main air injection tube 410 is provided to penetrate the first partition wall part 120. The main air injection tube 410 is provided along the long axis of the combustion chamber 100.

The first air (A1) flows inside the main air injection tube (410). The first air (A1) burns at the outlet side of the main air injection tube (410) and is injected into the combustion space (111). At this time, the inlet end of the main air injection tube (410) is sealed.

And, the main passing holes 420 are formed in a hole structure on the circumference of the inlet side of the main air injection tube 410. In addition, a plurality of main passing holes 420 are formed along the circumferential direction of the main air injection tube 410. The plurality of main passing holes 420 have a predetermined separation distance.

And, the air injection case 430 is formed in a sealed structure that at least surrounds the main passage holes 420.

On one side of the air injection case 430, a main air injection port 431 is formed through which the first air A1 is introduced. A separate air storage (not shown) may supply the first air A1 to the main air injection port 431.

At this time, the long axis of the main air injection port (431) is provided to intersect the long axis of the main air injection tube (410). That is, the main air injection port (431) supplies the first air (A1) to the side of the main construction tube. Accordingly, the first air (A1) is supplied in a direction intersecting the long axis of the main air injection tube (410).

If the first air (A1) is supplied coaxially with the long axis of the main air injection tube (410), the overall length of the facility is excessively increased, and it is difficult to arrange other components located behind the main air injection tube (410).

Therefore, preferably, as described above, the first air (A1) may be supplied in a direction intersecting the long axis of the main air injection pipe (410). In this case, the side space of the entire facility can be utilized effectively, minimizing the length of the entire facility. In addition, the layout design of other components can be performed more easily.

And, the air dividing part (440) is provided between the air injection case (430) and the main passage holes (420). Also, the air dividing part (440) is provided to surround the main passage holes (420).

A plurality of air dividing holes (441) having a hole structure are formed along the circumferential direction of the air dividing part (440). The air dividing holes (441) have a predetermined separation distance.

When the first air (A1) passes through the main air injection port (431), the first air (A) is filled inside the air injection case (430).

Inside the air injection case 430, the first air A1 is maximally uniformly distributed over the entire area of the air injection case 430 by the interference action of the air dividing part 440.

By passing through all the air division holes 441, the first air A1 is maximally uniformly distributed along the circumference of the inlet end of the main air injection tube 410. That is, the first air A1 is maximally uniformly distributed around all the main passing holes 420.

Therefore, at the inlet of the main air injection tube (410), the first air (A1) is uniformly introduced along the entire circumferential direction. Through the uniform introduction/supply action of the first air (A1), the combustion gas (G) is generated to be as identical as possible to the intended amount.

Here, preferably, the air division holes 441 may be spaced apart from the main passage holes 420 by a predetermined air movement distance AD along the inlet direction of the main air injection tube 410.

The first air A1 passing through the air division hole 441 does not directly flow into the main passage hole 420. That is, the first air A1 passing through the air division hole 441 moves toward the injection direction by a distance corresponding to the air movement distance AD, and then flows into the main passage hole 420.

Accordingly, as much as the air moving distance (AD) corresponds, the time that the first air (A1) stays and disperses between the air division hole (441) and the main passage hole (420) is further increased. Thereafter, the first air (A1) passes through all the main passage holes (420) more uniformly.

And, the main ammonia injection unit (450) is provided inside the main air injection pipe (410). The main ammonia injection unit is provided coaxially with the main air injection pipe (410). A separate ammonia reservoir (not shown) may supply the first ammonia (N1) to an inlet of the main ammonia injection unit (450).

And, at the outlet end of the main ammonia injection unit 450, a main injection nozzle 451 for injecting the first ammonia N1 is installed. The main injection nozzle 451 can adjust the injection flow rate, injection angle, etc. of the injected first ammonia N1.

And, the auxiliary air injection unit 460 may be provided in plurality along the outer circumferential direction of the main air injection pipe 410. The auxiliary air injection unit 460 injects the second air A2 toward the inside of the combustion chamber 100. The auxiliary air injection unit 460 may be supplied with the second air A2 from a separate air reservoir (not shown).

In this case, the second air (A2) may correspond to a kind of secondary air. The injection process of the second air (A2) may be controlled for combustion promotion, reduction of environmental pollutants, control of combustion amount, and various other purposes.

Further, an outlet end of the auxiliary air injection unit 460 may be spaced apart from an outlet end of the main air injection tube 410 by a predetermined distance toward an inlet end of the main air injection tube 410.

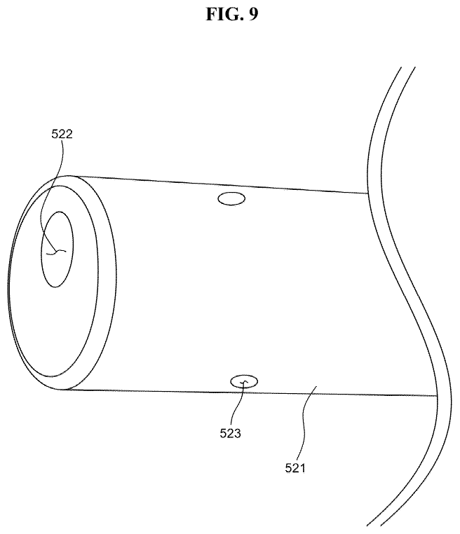

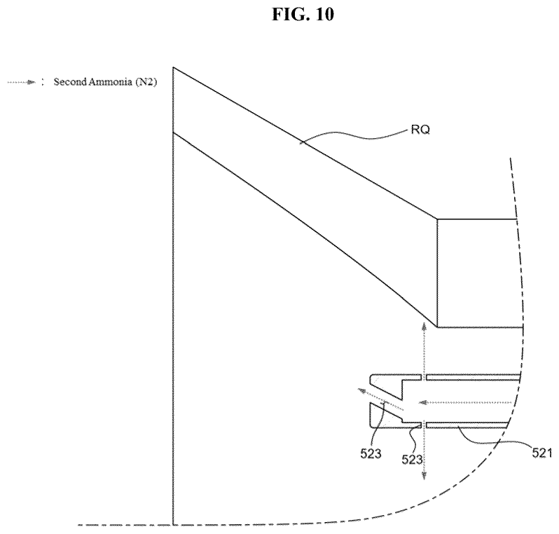

Next, FIG. 9 is a perspective view showing the auxiliary injection nozzle shown in FIG. 6, and FIG. 10 is a side cross-sectional view showing the auxiliary injection nozzle shown in FIG. 6.

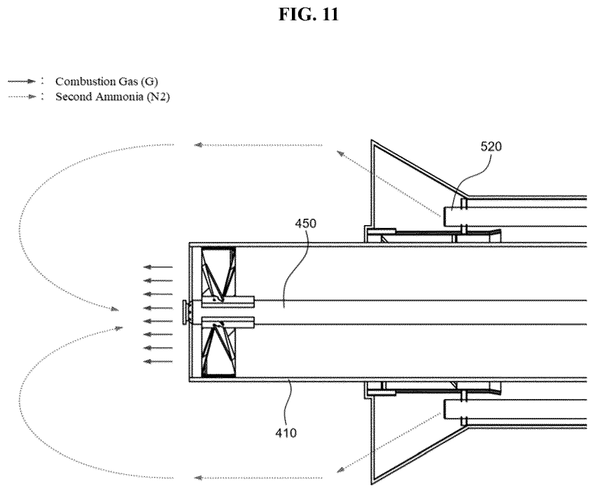

And, FIG. 11 is a schematic diagram illustrating a fluid flow on the side of the fuel injection part and the auxiliary ammonia injection part shown in FIG. 6.

FIGS. 9 to 11, the auxiliary ammonia injector 500 injects a second ammonia (N2). Similar to the second air A2, the injection process of the second ammonia N2 may be controlled for combustion promotion, reduction of environmental pollutants, control of combustion amount, and various other purposes.

In addition, the auxiliary ammonia injection unit 500 includes an auxiliary ammonia transfer pipe 510 and an auxiliary injection nozzle 520.

The auxiliary ammonia transfer pipe 510 is provided in plurality along the outer circumferential direction of the main air injection pipe 410. A separate ammonia storage (not shown) may supply the second ammonia (N2) to an inlet end of the auxiliary ammonia transfer pipe 510.

And, the auxiliary injection nozzle (520) is provided at an outlet end of the auxiliary ammonia transfer pipe (510). The auxiliary injection nozzle (520) adjusts an injection angle, an injection amount, and the like of the second ammonia (N2). Further, the auxiliary injection nozzle (520) includes an auxiliary nozzle body (521), a front nozzle hole (522), and a side nozzle hole (523).

The inlet end of the auxiliary nozzle body (521) communicates with the outlet end of the auxiliary ammonia transfer pipe (510). The outlet end of the auxiliary nozzle body (521) is closed. Here, the thickness of the outlet surface of the auxiliary nozzle body (521) is formed to be greater than the thickness of the peripheral side wall surface of the auxiliary nozzle body (521).

And, the front nozzle hole (522) is formed in a hole structure along the flow direction of the outlet end side of the auxiliary nozzle body (521).

In addition, the front-side nozzle hole 522 has a slope such that a separation distance from the main air injection tube 410 increases toward an exit direction. In addition, the plurality of front-side nozzle holes 522 have a kind of triangular pyramid-shaped flow path.

And, the side nozzle holes 523 are formed in a plurality of hole structures along the circumferential direction of the auxiliary nozzle body 521. In addition, the side nozzle holes 523 have a constant separation distance from each other. In addition, each of the side nozzle holes 523 is orthogonal to the long axis of the main air injection tube 410.

Accordingly, the second ammonia (N2) that has entered the auxiliary injection nozzle (520) side passes through the front nozzle hole (522) and the side nozzle holes (523) and is injected into the combustion space (111).

Here, a recirculation guiding part (RQ) is formed to surround the outside of the main air injection tube (410). In addition, the recirculation guiding part (RQ) has an inclination such that a separation distance from the main air injection tube (410) increases toward an exit direction. Further, the recirculation guiding part (RQ) has a kind of triangular pyramid shape provided coaxially with the main air injection tube (410).

The second ammonia (N2) is widely injected in a triangular pyramid shape by the plurality of forward nozzle holes 522. And, at least a part of the injected second ammonia (N2) moves toward the inner wall surface side of the recirculation inducer RQ. Next, the second ammonia (N2) recirculates while drawing an arc toward the outlet end of the main air injection pipe 410 on the inner wall surface side of the recirculation inducer RQ.

The second ammonia (N2) recirculated to the outlet end of the main air injection tube (410) promotes a combustion action at the outlet end side of the main air injection tube (410). Accordingly, the combustion temperature at the outlet end side of the main air injection tube (410) is increased.

That is, through the recirculation of the second ammonia (N2), the combustion temperature is increased and the combustion action becomes more active at the outlet side of the main air injection tube (410), so that incomplete combustion, which is a main cause of nitrogen oxide (NOx) generation, is minimized.

Here, preferably, the outlet ends of the side nozzle holes 523 face the inner surface of the recirculation guide RQ. The additional second ammonia N2 injected from the side nozzle

holes 523 further promotes the aforementioned recirculation process.

### Embodiment 1

The system according to the present embodiment is virtually simulated based on all of the preferable aspects of the aforementioned system 1000.

Here, two side nozzle holes (523) are provided.

### Comparative Example 1

This comparative example has the following differences from Example 1.

Compared to Embodiment 1, the combustion chamber (100) of the present comparative example has a length 2.5 times larger.

Unlike Embodiment 1, the exhaust manifold (200) in this comparative example does not have the main exhaust port (230) formed therein. That is, the combustion gas (G) is not discharged through the exhaust manifold (200) in this comparative example.

Compared to Embodiment 1, in the present comparative example, the combustion gas (G) is set to be discharged through the outlet end of the combustion chamber (100).

### Test Example 1-1

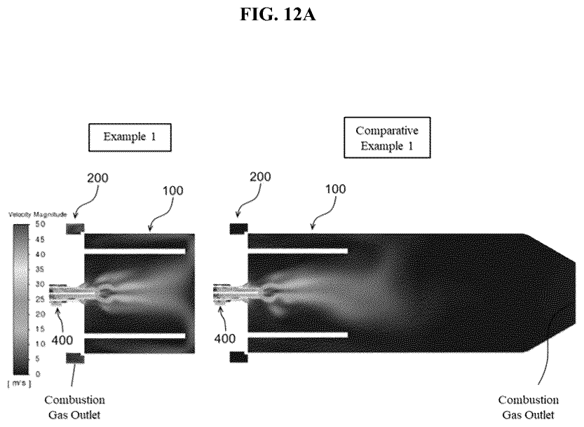

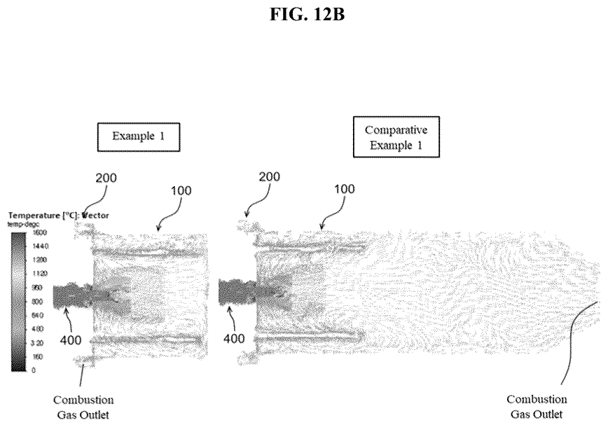

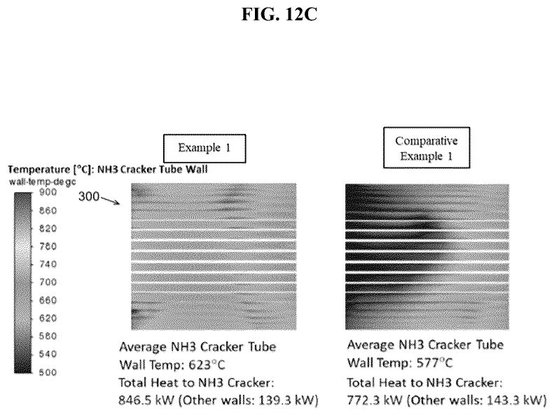

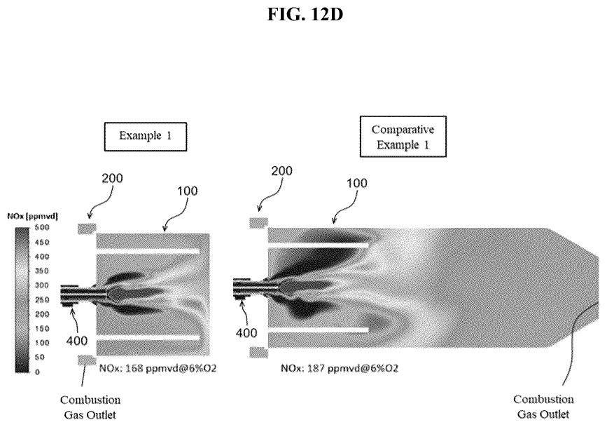

FIG. 12a is a computational fluid analysis result showing a difference in fluid flow velocity distribution between Example 1 and Comparative Example 1. Here, the fluid includes all fuel gases, all air, all combustion gases (G), and the like.

FIG. 12a further illustrates that ammonia combustion was virtually performed for Example 1 and Comparative Example 1.

As a result, it was confirmed that the combustion gas (G) in Embodiment 1 smoothly flowed into the inside of the exhaust manifold (200) after reaching the bottom surface of the combustion chamber (100).

On the other hand, in the case of Comparative Example 1, it was confirmed that the flow rate of the combustion gas (G) was extremely low at the bottom surface (exit) of the combustion chamber (100).

### Test Example 1-2

FIG. 12b is a computational fluid analysis result showing a temperature vector difference between Example 1 and Comparative Example 1.

FIG. 12b further illustrates that ammonia combustion was virtually performed for Example 1 and Comparative Example 1.

As a result, the outlet side temperature of the exhaust manifold (200), which is the combustion gas (G) outlet in Example 1, was measured to be 793° C.

On the other hand, in the case of Comparative Example 1, the temperature at the bottom surface of the combustion chamber (100), which is the outlet of the combustion gas (G), was measured to be 873° C.

That is, Example 1 has a remarkably shorter combustion chamber (100) length compared to Comparative Example 1, but has a lower combustion gas (G) exit temperature.

At this time, Embodiment 1 has a difference that the combustion gas (G) circulates the long axis of the combustion chamber (100) compared to the comparative example, and a difference that the main exhaust port (230) of the exhaust manifold (200) is formed at the circulation end point of the combustion gas (G). Due to these differences, a combined advantage of much more advantageous space utilization and a lower outlet temperature is provided.

### Test Example 1-3

FIG. 12c is a computational fluid dynamics analysis result showing a difference in temperature distribution on the ammonia decomposition unit side between Example 1 and Comparative Example 1.

FIG. 12c further illustrates that ammonia combustion was virtually performed for Example 1 and Comparative Example 1.

As a result, inside the reformer (100) in Example 1, the surface average temperature of the ammonia decomposition part (300) side was measured to be 623° C. Also, the surface average thermal energy of the ammonia decomposition part (300) side was measured to be 846.5 kW.

On the other hand, the surface average temperature of the ammonia decomposition unit (300) of Comparative Example 1 was measured to be 577° C. Also, the surface average thermal energy of the ammonia decomposition unit (300) was measured to be 772.3 kW.

Therefore, it was confirmed that Example 1 performs heat transfer more smoothly to the ammonia decomposition unit (300) than Comparative Example 1. As the efficiency of heat transfer to the ammonia decomposition unit (300) increases, the decomposition efficiency of ammonia for decomposition (NT) is further improved.

That is, a complex effect occurs in which the outlet temperature (Test Example 1-2), which is closely related to industrial safety and environmental pollution, is low, and the heat transfer efficiency (Test Example 1-3) to the ammonia decomposition unit 300 is high.

### Test Example 1-4

FIG. 12d is a computational fluid dynamics analysis result showing the difference in nitrogen oxide concentration distribution between Example 1 and Comparative Example 1.

Referring to FIG. 12 d, ammonia combustion was virtually performed for Example 1 and Comparative Example 1.

As a result, in the case of Example 1, the outlet-side nitrogen oxide concentration of the exhaust manifold 200, which is the combustion gas (G) outlet, was measured to be 168 ppm.

On the other hand, in the case of Comparative Example 1, the nitrogen oxide concentration at the bottom surface of the combustion chamber (100), which is the outlet of the combustion gas (G), was measured to be 187 ppm.

Therefore, it was confirmed that Example 1 has a significantly higher nitrogen oxide reduction efficiency compared to Comparative Example 1. Accordingly, it was confirmed that Example 1 further reduces the emission of environmentally harmful substances, such as nitrogen oxides, compared to Comparative Example 1.

### Comparative Example 2

This comparative example has the following differences from Example 1.

Compared to Embodiment 1, the side nozzle hole 523 is not applied to this comparative example.

### Experimental Example 2-1

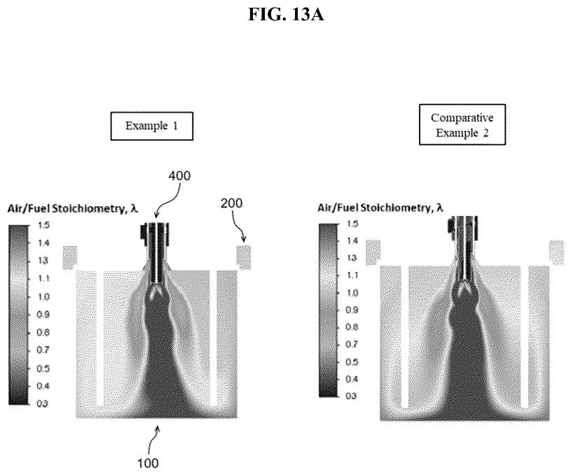

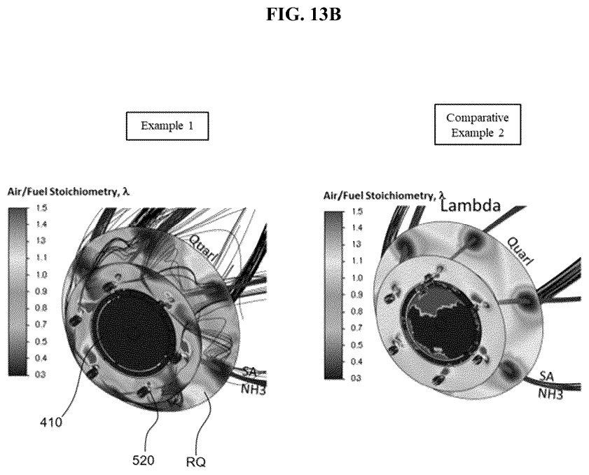

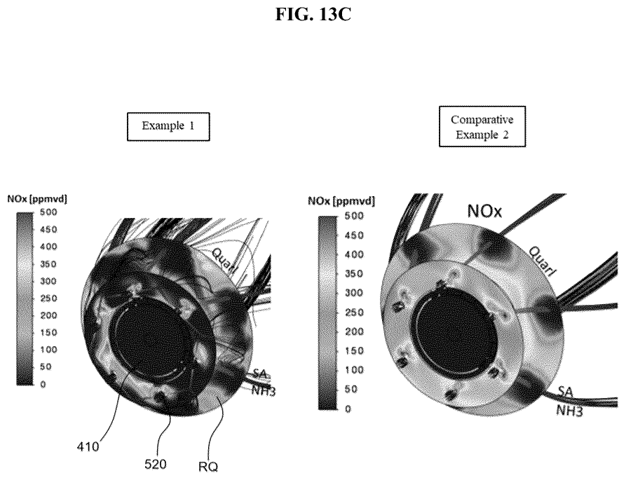

FIG. 13a is a computational fluid dynamics analysis result showing the difference in stoichiometric coefficient distribution between Example 1 and Comparative Example 2. And, FIG. 13b is a computational fluid dynamics analysis result showing the difference in stoichiometric coefficient distribution on the recirculation induction part side between Example 1 and Comparative Example 2.

FIGS. 13a and 13b further illustrate that ammonia combustion was virtually performed for Example 1 and Comparative Example 2.

Here, the stoichiometric coefficient mentioned through FIGS. 13a and 13b means a relative ratio of air required for complete combustion of ammonia fuel. In the examples and comparative examples, since conditions of air supply amount and fuel (ammonia) supply amount are the same, it is possible to determine how uniform the distribution of ammonia fuel and air is through stoichiometric coefficient analysis.

As a result, referring to FIG. 13a, it was found that the stoichiometric coefficient was uniformly distributed with a considerably low value on the fuel injection unit 400 side in Example 1. On the other hand, it was found that there were many points where the stoichiometric coefficient was extremely high on the fuel injection unit 400 side in Comparative Example 2.

In particular, referring to FIG. 13b, it can be seen that the maximum, average, and uniformity difference of the stoichiometric coefficient are significant in the entire recirculation guide part (RQ) closest to the auxiliary injection nozzles 520.

Therefore, it was confirmed that the side nozzle hole (523) of the auxiliary ammonia injection unit (500) has an effect of further improving the distribution of the ammonia fuel.

### Test Example 2-2

FIG. 13c is a computational fluid dynamics analysis result showing the difference in nitrogen oxide concentration distribution on the recirculation inducing unit side for Example 1 and Comparative Example 2.

Referring further to FIG. 13c, ammonia combustion was virtually performed for Example 1 and Comparative Example 2.

As a result, it was confirmed that Example 1 had an extremely low nitrogen oxide concentration in the recirculation guide unit (RQ) compared to Comparative Example 2. In this regard, it is analyzed that ammonia injected from the side nozzle hole (523) smoothly induces complete combustion of the entire ammonia injected from the auxiliary injection nozzle (520).

Therefore, Example 1 was confirmed to have a significantly higher complete combustion rate and nitrogen oxide reduction efficiency compared to Comparative Example 2. In addition, regarding the results of this test, the difference in ammonia distribution (Test Example 2-1) described above was analyzed as a major factor.

As described above, the present disclosure has an ammonia combustion and reforming system for high-efficiency hydrogen production as a main technical idea. The embodiments described above with reference to the drawings are only some examples, and the scope of the present disclosure should be determined based on the claims. In addition, the scope of the present disclosure extends to equivalent embodiments that can be derived in various ways.

What is claimed is:

1. An ammonia combustion and reforming system for high-efficiency hydrogen production, comprising:
a combustion chamber;
a fuel injection unit configured to generate combustion gas by combusting at least first air and first ammonia inside the combustion chamber; and
an ammonia decomposition unit disposed at least partially inside the combustion chamber and configured to decompose feed ammonia,
wherein thermal energy of the combustion gas is transferred into the ammonia decomposition unit so that the feed ammonia is decomposed to produce decomposed gas.

2. The system of claim 1,
wherein the ammonia decomposition unit comprises:
an inlet pipe for decomposition feedstock having an inlet end connected to outside of the combustion chamber and an outlet end disposed inside the combustion chamber; and
an outlet pipe for decomposed gas disposed at least partially inside the combustion chamber, the outlet pipe being in communication with the inlet pipe and configured to discharge the decomposed gas to the outside of the combustion chamber.

3. The system of claim 2,
wherein the inlet pipe for decomposition feedstock has an open inlet end and an open outlet end, and the outlet pipe for decomposed gas comprises:
an inlet-side partition wall facing the outlet end of the inlet pipe and spaced apart therefrom by a predetermined distance; and
an outer pipe extending from the inlet-side partition wall, surrounding an outer wall of the inlet pipe, and spaced apart from the outer wall of the inlet pipe by a predetermined distance,
wherein the decomposed gas is supplied to the outside of the combustion chamber through an outlet of the outer pipe.

4. The system of claim 3,
further comprising an exhaust manifold installed at an inlet end of the combustion chamber and communicating with the inside of the combustion chamber to discharge the combustion gas,
wherein at least a portion of the combustion gas circulates at least once along a longitudinal axis of the combustion chamber before flowing into the exhaust manifold.

5. The system of claim 4,
wherein the combustion chamber comprises:
a main body having an inner hollow structure opened at both ends;
a first partition wall closing an inlet end of the main body; and
a second partition wall closing an outlet end of the main body.

6. The system of claim 5,
wherein the exhaust manifold is provided coaxially with and outside the first partition wall.

7. The system of claim 6,
wherein the combustion chamber comprises a plurality of intermediate exhaust passages formed along a circumferential direction of the first partition wall and spaced apart from each other, and
the exhaust manifold comprises:
a manifold body having a sealed structure and provided along the circumferential direction of the first partition wall;
a passage connection portion provided along the circumferential direction of the manifold body and communicating with the plurality of intermediate exhaust passages; and
a main exhaust port communicating between an inside and an outside of the manifold body.

8. The system of claim 1,
wherein the fuel injection unit comprises:
a main air injection pipe through which the first air is discharged;
a plurality of main through-holes formed as holes along a circumferential direction near an inlet end of the main air injection pipe and spaced apart from each other by predetermined distances; and
an air supply case surrounding the plurality of main through-holes and configured to supply the first air to the plurality of main through-holes.

9. The system of claim 8,
wherein the fuel injection unit further comprises:
an air dividing portion provided between the air supply case and the plurality of main through-holes and surrounding the plurality of main through-holes; and
a plurality of air division holes formed as holes along a circumferential direction of the air dividing portion and spaced apart from each other by predetermined distances.

10. The system of claim 9,
wherein the plurality of air division holes are spaced apart from the plurality of main through-holes by a predetermined distance along an inlet direction of the main air injection pipe.

11. The system of claim 1, further comprising an auxiliary ammonia injection unit provided outside the fuel injection unit and configured to inject second ammonia into the inside of the combustion chamber.

12. The system of claim 11,
wherein the auxiliary ammonia injection unit comprises:
an auxiliary ammonia transfer pipe through which second ammonia flows; and
an auxiliary injection nozzle provided at an outlet end of the auxiliary ammonia transfer pipe.

13. The system of claim 12,
wherein the auxiliary injection nozzle comprises:
an auxiliary nozzle body; and
a front nozzle hole formed as a hole along a flow direction at an outlet end side of the auxiliary nozzle body.

14. The system of claim 13,
wherein the front nozzle hole has an inclination such that a distance from the fuel injection unit increases toward an outlet direction, and a recirculation guide portion surrounding the outside of the fuel injection unit is formed with an inclination that increases a spacing from the fuel injection unit toward the outlet direction.

15. The system of claim 14,
wherein the auxiliary injection nozzle further comprises a plurality of side nozzle holes formed as holes along a circumferential direction of the auxiliary nozzle body.

16. The system of claim 15,
wherein each of the side nozzle holes is oriented perpendicularly to a longitudinal axis of the nozzle body, and an outlet end thereof faces an inner surface of the recirculation guide portion.
